(19) United States
(12) Patent Application Publication
(10) Pub. No.: US 2014/0163143 A1
(43) Pub. Date: Jun. 12, 2014

(54) FLAME-RESISTANT ELASTOMERIC COMPOSITION AND USE THEREOF

(71) Applicant: The Moore Company, Westerly, RI (US)

(72) Inventors: Raju H. Chudamani, Toms River, NJ (US); Patrick Murphy, Greenfield, MA (US)

(21) Appl. No.: 14/093,515

(22) Filed: Dec. 1, 2013

Related U.S. Application Data
(63) Continuation of application No. PCT/US2012/040616, filed on Jun. 1, 2012.
(60) Provisional application No. 61/492,345, filed on Jun. 1, 2011.

(51) Int. Cl. C08L 47/00

(52) U.S. Cl. CPC C08L 47/00
USPC 524/81; 524/519; 524/405

(57) ABSTRACT

Novel elastomeric compositions and articles are disclosed. Methods of making and using the compositions and articles are also disclosed.

### RELATED APPLICATIONS

This application is a continuation of PCT Patent Application No. PCT/US2012/040616, filed Jun. 1, 2012, which claims the benefit of and priority to U.S. Provisional Patent Application Ser. No. 61/492,345, filed Jun. 1, 2011. The contents of each of the foregoing applications are incorporated herein by reference in their entirety.

### BACKGROUND

The various situations requiring elastic materials have led to the development of a wide range of natural and synthetic rubbers. Certain demanding situations have required blends of these rubbers to provide the proper mix of characteristics. For example, vehicle tires often include styrene-butadiene rubber (SBR), which is the most common synthetic elastomer, polybutadiene (BR), and even natural rubber. The characteristics usually associated with natural rubber, i.e., abrasion resistance, resilience, good high- and low-temperature performance, and tear strength are ideal for tires and similar applications, which experience great punishment.

However, other environments have less demanding strength requirements, but make other strict demands on elastomers. For example, in the clothing industry, elastomers used for form fitting clothing have a unique set of requirements. These include a low stretch modulus, high dimensional stability (to retain the article's shape), low permanent set (to avoid losing the snug fit of a garment), and tear resistance (to avoid tearing while being punctured by the sewing needle). These demands are compounded, for example, when the garment is swimwear. In this area, in addition to the clothing fit requirements, the garment may be exposed to large amounts of sunlight, chlorine from pool water, salt-water, and oils from body perspiration and sun protection lotions. Clothing for military and industrial personnel should ideally be durable and provide protection from hazards such as solvents and flame.

A common choice of elastomer for clothing elastication purposes is natural rubber (cis-1,4-polyisoprene). It provides excellent elongation properties, can be made soft, has very good tear resistance and is strong (i.e., has excellent tensile strength). However, it is severely deficient in resistance to flame, sunlight, oils, or chlorine. A common synthetic substitute for natural rubber in clothing is Neoprene, which has excellent resistance to flame, oil, ozone, abrasion and solvents, but is not as elastic as natural rubber.

Improved elastomers for use in flame-resistant clothing are needed.

### SUMMARY OF THE INVENTION

The invention relates generally to flame-resistant elastomeric compositions, to articles made from such compositions, and to methods of making the compositions and articles.

In one aspect, the invention provides a composition comprising:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition comprising:
(a) 100 parts polychloroprene-based polymer, comprising
   (i) about 60 parts polychloroprene co-polymer; and
   (ii) about 40 parts polychloroprene homopolymer;
(b) 50-70 parts flame retardant, wherein the flame retardant comprises a mixture of aluminum trihydroxide, chlorinated paraffin wax, antimony oxide, and zinc borate; and
(c) 5-7 parts curing agent, wherein the curing agent comprises zinc oxide and salicylic acid.

In another aspect, the invention provides a composition prepared by combining:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition prepared by combining:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition which is prepared by combining:
(a) 100 parts polychloroprene-based polymer, comprising
   (i) about 60 parts polychloroprene co-polymer; and
   (ii) about 40 parts polychloroprene homopolymer;
(b) 50-70 parts flame retardant, wherein the flame retardant comprises a mixture of aluminum trihydroxide, chlorinated paraffin wax, antimony oxide, decabromo diphenyl ether, and zinc borate; and
(c) 5-7 parts curing agent, wherein the curing agent comprises zinc oxide and/or salicylic acid.

In another aspect, the invention provides methods for preparing elastomeric compositions.

In certain embodiments of any of the above aspects, the polychloroprene co-polymer is a polychloroprene co-polymer is a 2,3 dichloro 1,3-butadiene copolymer. In certain embodiments of any of the above aspects, the polychloroprene co-polymer is Neoprene WRT and the polychloroprene homopolymer is Neoprene WB. In certain embodiments of any of the above aspects, the ratio of (i) to (ii) is about 60:40.

In certain embodiments of any of the above aspects, the flame retardant comprises one or more of aluminum trihydroxide, chlorinated paraffin wax, antimony oxide, decabromo diphenyl ether or zinc borate.

In certain embodiments of any of the above aspects, the curing agent comprises one or more of zinc oxide or salicylic acid.

In certain embodiments of any of the above aspects, the composition further comprises one or more of a peptizing agent, a pigment, a scorch inhibitor, a homogenizing agent, a cure activator, an antioxidant, or a release agent.

In another aspect, the invention provides an elastomeric thread comprising any of the above compositions.

In another aspect, the invention provides an elastomeric thread, wherein the elastomeric thread has modulus at 300% strain of at least 450 psi, and an afterflame of no more than 1.1 seconds as measured by the method of ASTM D-6413.

In another aspect, the invention provides a fabric comprising an elastomeric thread as disclosed herein.

In another aspect, the invention provides an article of clothing comprising a fabric as disclosed herein.

In another aspect, the invention provides an article of manufacture comprising a composition of the invention.

### DETAILED DESCRIPTION OF THE INVENTION

The present inventions relates to flame retardant elastomeric compositions comprising polychloroprene, artilces (such as threads or garments) made with the elastomeric compositions, and to methods for making and using the same.

In one embodiment, the invention provides a composition comprising:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition comprising:
(a) 100 parts polychloroprene-based polymer, comprising
   (i) about 60 parts polychloroprene co-polymer; and
   (ii) about 40 parts polychloroprene homopolymer;
(b) 50-70 parts flame retardant, wherein the flame retardant comprises one or more of aluminum trihydroxide, chlorinated paraffin wax, antimony oxide, decabromo diphenyl ether and zinc borate; and
(c) 5-7 parts curing agent, wherein the curing agent comprises zinc oxide and/or salicylic acid.

In another aspect, the invention provides a composition comprising:
(a) 100 parts polychloroprene-based polymer, comprising
   (i) about 60 parts polychloroprene co-polymer; and
   (ii) about 40 parts polychloroprene homopolymer;
(b) 50-70 parts flame retardant, wherein the flame retardant comprises a mixture of aluminum trihydroxide, chlorinated paraffin wax, antimony oxide, and zinc borate; and
(c) 5-7 parts curing agent, wherein the curing agent comprises zinc oxide and salicylic acid.

In another aspect, the invention provides a composition prepared by combining:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition prepared by combining:
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent.

In another aspect, the invention provides a composition which is prepared by combining:
(a) 100 parts polychloroprene-based polymer, comprising
   (i) about 60 parts polychloroprene co-polymer; and
   (ii) about 40 parts polychloroprene homopolymer;
(b) 50-70 parts flame retardant, wherein the flame retardant comprises one or more of (or a mixture of) aluminum trihydroxide, chlorinated paraffin wax, antimony oxide, decabromo diphenyl ether, and zinc borate; and
(c) 5-7 parts curing agent, wherein the curing agent comprises zinc oxide and/or salicylic acid.

In another aspect, the invention provides methods for preparing elastomeric compositions. In one embodiment, the invention provides a method for preparing an elastomeric composition, the method comprising the step of combining
(a) 100 parts polychloroprene-based polymer, comprising
   (i) polychloroprene co-polymer; and
   (ii) polychloroprene homopolymer;
   wherein the ratio of (i) to (ii) is between 20:80 and 80:20;
(b) 30-90 parts flame retardant; and
(c) 3-9 parts curing agent. In certain embodiments, the combining step comprises combining the components in a mixer. In certain embodiments, the method includes the further step of curing the composition.

In another aspect, the invention provides a method of preparing an elastomeric sheet. In certain embodiments, the method comprises the step of calendering an elastomeric composition of the invention to produce an elastomeric sheet.

In certain embodiments of any of the above aspects, the polychloroprene co-polymer is a polychloroprene co-polymer is a 2,3 dichloro 1,3-butadiene copolymer. In certain embodiments of any of the above aspects, the polychloroprene co-polymer is Neoprene WRT and the polychloroprene homopolymer is Neoprene WB. In certain embodiments of any of the above aspects, the ratio of (i) to (ii) is about 60:40.

In certain embodiments of any of the above aspects, the flame retardant comprises one or more of aluminum trihydroxide, chlorinated paraffin wax, antimony oxide, decabromo diphenyl ether or zinc borate.

In certain embodiments of any of the above aspects, the curing agent comprises one or more of zinc oxide or salicylic acid.

In certain embodiments of any of the above aspects, the composition further comprises one or more of a peptizing agent, a pigment, a scorch inhibitor, a homogenizing agent, a cure activator, an antioxidant, or a release agent.

In certain embodiments, the composition is a composition of Table 1 or of any of the Examples herein.

In another aspect, the invention provides an elastomeric thread comprising any of the above compositions.

In another aspect, the invention provides an elastomeric thread, wherein the elastomeric thread has modulus at 300% strain of at least 450 psi, and an afterflame of no more than 1.1 seconds as measured by the method of ASTM D-6413.

In another aspect, the invention provides a fabric comprising an elastomeric thread as disclosed herein.

In another aspect, the invention provides an article of clothing comprising a fabric as disclosed herein.

Polychloroprene rubbers useful in the present compositions, materials, and methods include general purpose, extrudable polychloroprenes; in certain embodiments, the polychloroprene is a mercaptan-modified polychloroprene such as, e.g. Dupont Neoprene W, WRT. Other suitably employed polychloroprenes include Petrotex Neoprene M-1, Bayer Bayprene 210, 220 and Plastimere Butachlor MC-10. Manufacturers of suitable polychloroprenes include Dupont (including Dupont Neoprene WB and WRT), Lanxess (such as Lanxess 110 and 214), Lianda, and Tosoh. These polychloroprenes are polymers of 2-chloro-1,3-butadiene that are solids with a specific gravity desirably between about 1.23 and 1.25 at 25/4° C., and especially suitable polychloroprene are those with medium Relative Mooney viscosity, e.g., in area of 50 ASTM D 1646, ML at 100° C., 2.5 minute reading. Blends of polychloroprenes may be used.

The polychloroprene rubber components are preferably supplied in a bulk crumb or chip form. The polychloroprene rubber component and additional ingredients are mixed, for example, in a mixer (e.g., a Banbury mixer) for a time sufficient to mix the components into a uniform blend. The resulting blends have a high degree of homogeneity. Other conventional mixers, such as an open mill mixer, rubber mill, or twin-screw continuous mixer may also be used.

While the mixing continues, additional ingredients are added. Such ingredients may include, but are not limited to, accelerators, antioxidants, prevulcanization inhibitors, reinforcement fibers, pigments, dyes, and process oils. These and other processing aids are added in normal fashion depending on the specific mixing protocol used. Such techniques are well known to those skilled in the art. Exemplary components and their parts per hundred rubber for a specific but non-limiting embodiment are shown in Table 1. Alternate vulcanizing/accelerator combinations commonly used for rubber compounding may also be used with similar results.

The term “part”, as used herein, refers to “parts per hundred rubber” (phr) unless otherwise stated.

TABLE 1

| | PHR |
|---|---|
| Component | (Parts Per Hundred Rubber) |
| Polychloroprene co- | 60 |
| polymer | |
| Polychloroprene | 40 |
| homopolymer | |
| Pigment (e.g., carbon | 2.63 |
| black) | |
| Vulcanizer (e.g., | 5.5 |
| Magnesium oxide) | |
| Peptizer | 0.5 |
| Processing aids | 11 |
| Activator | 0.5 |
| Antioxidant | 1 |
| Flame retardants | 60.45 |
| Curing agents | 6.13 |

Additional components that may be added or substituted in the above formulation include: polybutadiene (3-10 PHR); Struktol-brand process aids, instead of or in addition to Peptizer E-19204; Oppanol™ polyisobutylene for improved bonding; CPW 100 (Harwick) or Chlorez 700 (Dover) instead of or in addition to Chlorflo 42; and Aflux 16 dispersant/lubricant (Rhein Chemie) as a process aid.

In certain embodiments, the flame retardant comprises one or more of aluminum trihydroxide (including Hydral 710 brand), chlorinated paraffin wax (e.g., Akrochlor- or Chloroflo-brand waxes, or CPW-100), antimony oxide (including PPL(S-BOX)90MV), decabromo diphenyl ether, or zinc borate (including FIREBRAKE brand zinc borate). In certain embodiments, the amount of flame retardant is about 50-70 parts (phr).

In certain embodiments, the curing agent comprises one or more of zinc oxide (including Rhenogran ZnO 85 and/or O(ZnO)70) and salicylic acid. In certain embodiments, the amount of curing agent is 3-9 parts (phr), or about 5-7 parts (phr).

In certain embodiments, the processing aid comprises one or more of polyoctenemer-based rubber, polyethylene wax, and the like. In certain embodiments, the amount of processing aid is about 9-12 or about 11 parts (phr).

In certain embodiments, the peptizer comprises an aryl amine hydrocarbon mixture (e.g., Peptizer E-19204), zinc soaps of fatty acids, and the like. In certain embodiments, the amount of peptizer is about 0-1 parts (phr).

In certain embodiments, the antioxidant comprises one or more of butylated aromatic antioxidants including butylated reaction products of p-cresol and dicyclopentadiene (e.g., Wingstay L brand). In certain embodiments, the amount of antioxidant is about 0.5 to about 2 parts (phr), or in certain embodiments, about 1 part (phr).

In certain embodiments, the pigment is carbon black (e.g., 1605 Black MB). In certain embodiments, the amount of pigment is about 0.1-3 parts (phr).

In certain embodiments, the vulcanizer is magnesium oxide (e.g., Elastomag brand). In certain embodiments, the amount of vulcanizer is about 5-6 parts (phr).

In certain embodiments, the activator may include zinc oxide and/or stearic acid as shown in Example 1. In certain embodiments, the amount of activator is about 0.5-7 parts (phr).

Thus, for example, in certain embodiments, a composition according to the invention comprises polychloroprene co-polymer (i) (20-80 phr), polychloroprene homopolymer (ii) (20-80 phr, such that (i) +(ii) equals 100 phr), pigment 0.1-3 phr, vulcanizer (5-6 phr), peptizer (0-1 phr), processing aids (9-12 phr), activator (0.5-7 phr), antioxidant (0.5-2 phr), flame retardants (50-70 phr) and curing agents (3-9 phr).

In certain embodiments, a reinforcing filler, such as precipitated silica, may be added; for example, the HI-SIL filler available from PPG Industries Inc. can be used. A non-reinforcing filler such as talc or calcium carbonate or other soft filler may also be used and may include titanium dioxide, which can be totally or partially replaced with silica filler and/or clays. Conventional antioxidants, such as those from the hindered phenol family, may be used, for example, the WINGSTAY L antioxidant available from Eliokem, as shown in Table 1, or other antioxidants. If desired, a process oil or extender such as naphthenic oil may be added, for example, in the range of 0-20 parts per hundred rubber.

In certain embodiments, the invention provides an elastomeric composition having substantially no free carbon black. In certain embodiments, the invention provides an elastomeric composition having low hysteresis (e.g., less than 50%, e.g., about 45%), low permanent set (e.g., less than about 18% maximum in a 20-minute test), and consistent runability. In certain embodiments, the invention provides a thin-gauge calendered elastic. In certain embodiments, the invention provides an uncovered (e.g., not covered with yarn), no melt-no drip elastic.

### Threads and Tapes

The elastomeric compositions of the invention can be used to prepare tapes, threads, or other articles for use in garments and other applications. For example, a cured elastomeric sheet can be slit into tape form with various widths as desired, using conventional slitters or other apparatus as is known in the art. The individual slit ends may be bonded together in groups to promote easier covering or maybe be spooled onto cores as single ends.

### Fabrics and Garments

Flame-resistant fabrics and garments can be prepared using the present elastomeric threads, e.g., according to methods known in the art. For example, flame-resistant fabrics and garments can be prepared according the methods described in U.S. Pat. No. 5,694,981, which describes a fabric formed from a series of flame resistant warp yams interwoven with a series of filling yams. The filling yarns comprise core yarns formed from an elastic material, wrapped with a series of wrap yams formed from a flame resistant material. The present elastomeric thread can be used as an elastic material, e.g., in the methods of U.S. Pat. No. 5,694,981 to provide improved flame resistance.

In general, the flame retardant elastomeric compositions of the present invention, when formed into threads or fibers, e.g., by the techniques described herein, can be woven or knitted into fabric structures exhibiting good mechanical and recovery properties and having excellent fire retardant characteristics. Moreover, the flame retardant elastomeric threads can be blended by techniques such as knitting, weaving, etc., with nonelastic, high strength materials such as fibrous polybenzimidazoles, nylons, and the like, to produce articles of manufacture having high mechanical strength and exhibiting excellent flame retardant properties. Rigid non-woven structures can also be produced from the flame retardant compositions of the present invention.

### EXAMPLES

The following examples are provided for illustration and not limitation.

### Example 1

### Polychloroprene Formulation

A polychloroprene formulation of the invention was prepared by mixing various components in the proportions set forth in the table below. A source (e.g., commercial vendor) for each component is also provided.

| | PHR | |
|---|---|---|
| | (Parts Per Hundred | |
| Component | Rubber) | Vendor |
| Neoprene WRT | 60 | RT Vanderbilt |
| Neoprene WB | 40 | RT Vanderbilt |
| 1605 Black MB | 2.63 | ISP Elastomers |
| Elastomag 170 | 5.5 | Akrochem |
| Peptizer E-19204 | 0.5 | Akrochem |
| Vestenamer 8012 | 5 | Struktol |
| Stearic Acid | 0.5 | Lincoln Fine Ingredients |
| Wingstay L | 1 | Eliokem |
| Akrowax PE-LM | 6 | Akrochem |
| Hydral 710 | 36 | Akrochem |
| Chloroflo 42 DLC | 13.89 | Polychem Dispersions |
| PPL(S-BOX)90 MV | 5.56 | Polychem Dispersions |
| Firebreak ZB | 5 | Harwick Standard |
| O(ZnO)70 | 3.42 | Polychem Dispersions |
| Salicylic Acid 5314 | 2.55 | Excel Polymers |
| MB | | |
| Rhenogran ZnO 85 | 0.16 | Rhein Chemie |

### Example 2

### Additional Polychloroprene Elastic Compositions

In addition to the formulation of Example 1, the following formulations were prepared:

| | PHR | | |
|---|---|---|---|
| | (Parts Per | | |
| | Hundred Rubber) | | |
| | Formulation | | |
| Component | #2 | #3 | #4 |
| Neoprene WRT | 60 | 60 | 60 |
| Neoprene WB | 40 | 40 | 40 |
| 1605 Black MB | 3.5 | 3.5 | 3.5 |
| Elastomag 170 | 5.5 | 5.5 | 5.5 |
| (magnesium oxide) | | | |
| Peptizer E-19204 | 0.5 | 0.5 | 0.5 |
| Vestenamer 8012 | 5 | 5 | 5 |
| (trans-polyoctenamer- | | | |
| based rubber) | | | |
| Stearic Acid | 0.5 | 0.5 | 0.5 |
| Wingstay L | 1 | 1 | 1 |
| AcPoly | 6 | 6 | 6 |
| Hydral 710 | 36 | 36 | 36 |
| Chloroflo 42 DLC | 10 | 0 | 0 |
| Antimony oxide | 5 | 5 | 5 |
| Firebreak ZB (zinc | 5 | 5 | 5 |
| borate) | | | |
| Dekabromo | 0 | 10 | 0 |
| (Decabromo diphenyl | | | |
| ether flame retardant) | | | |
| Akrochlor R70 | 0 | 0 | 10 |

### Example 3

### Additional Polychloroprene Elastic Composition

The following formulation was prepared:

| | PHR |
|---|---|
| | (Parts Per Hundred Rubber) |
| | Formulation |
| Component | #5 |
| Neoprene WRT | 60 |
| Neoprene WB | 40 |
| Pigment (carbon black) | 2.63 |
| Magnesium oxide | 5.5 |
| Processing aids | 7.5 |
| (polyethylene wax, | |
| Akrowax PE-LM | |
| dispersant/lubricant) | |
| Polybutadiene, | 5 |
| polyisoprene, | |
| polyisobutylene | |
| Flame retardants | 53 |
| (antimony oxide, | |
| aluminum hydroxide, | |
| zinc borate, chlorinated | |
| paraffin wax) | |
| Stearic Acid | 0.5 |
| Antioxidant | 1 |
| Curing agents (zinc | 6.13 |
| oxide, salicyclic acid) | |

### Example 4

### Additional Polychloroprene Elastic Composition

The following formulation was prepared:

| | PHR |
|---|---|
| | (Parts Per Hundred Rubber) |
| | Formulation |
| Component | #6 |
| Neoprene WRT | 60 |
| Neoprene WB | 40 |
| Dye | 0.13 |
| Titanium dioxide | 5 |
| Magnesium oxide | 5.5 |
| Processing aids | 7.5 |
| (polyethylene wax, | |
| dispersant/lubricant) | |
| Polybutadiene, | 5 |
| polyisoprene, | |
| polyisobutylene | |
| Flame retardants | 53 |
| (antimony oxide, | |
| aluminum hydroxide, | |
| zinc borate, chlorinated | |
| paraffin wax) | |
| Stearic Acid | 0.5 |
| Antioxidant | 1 |
| Curing agents (zinc | 6.13 |
| oxide, salicyclic acid) | |

### Example 5

### Process to Make a Polychloroprene Elastic Thread/Fiber

General Procedures: First, the components of the formula of Example 1 are mixed in a mixer, and the obtained compound is converted to an elastic film/sheet of desired thickness on a rubber calender. The elastic film/sheet is vulcanized with heat/time in a hot air oven, and then cooled to provide a cured sheet. The cured sheet is then slit into thread form with a desired width.

### Detailed Process

Polychloroprene rubber (and/or a blend of other organic rubbers) is mixed in the drop mill of a Banbury mixer for a time sufficient to ensure that the components are properly dispersed in the batch. The rubber is cut and passed through the mill gap at least two times. The cure package is added at the accelerator mill The temperature is controlled during the mixing and curing process.

The above batch is loaded onto an accelerator mill Additional ingredients (see Table 1) are then added. At the completion of mixing, uniform color and appearance of the batch ensures that it is properly mixed

The batch is fed to the calender to produce a quality sheet of rubber. The running parameters of the calender are adjusted to provide the required caliper and surface finish, and talc is applied to prevent layers from adhering to each other during the vulcanization process.

Wrapped shells are removed from wrapper unit, and are transported to vulcanizing. When possible, two shells are cured in each oven. Shells are loaded into oven by positioning the shells onto tracks leading into oven, and pins are inserted. At the completion of loading, the shells are locked into position, and are rotated during curing cycle. The oven is set at the specified temperature (e.g., 300-310° F./149-154° C.). Vulcanizing is continued until all products are vulcanized (based on a calculated curing time). The shells are removed and cooled for at least one hour minimum before unwrapping.

The cured sheet as above obtained is then slit into tape form with various widths. The individual slit ends may be bonded together in groups to promote easier covering or may be spooled onto cores as single ends. The configuration will depend on end application, as will be apparent to the skilled artisan.

### Example 6

In certain embodiments, threads prepared from the elastomeric materials of the invention can have the following properties:

Elastic Threads: For weaving, braiding, covering, and knitting of narrow and circular fabrics.

Material: Synthetic polychloroprene, flame resistant thread.

Thickness Range: 0.012″ to 0.048″ (0.30 mm to 1.22 mm)

Standard Widths: 0.019″, 0.023″, 0.027″, 0.033″, 0.038″, 0.054″, 0.057

End Count 6 to 90 depending on width, or single end spools (2″ core)

### Configuration:

### Exemplary Physical Properties

Modulus @300% 450 psi
Tensile 2500 psi minimum
Elongation At Break: >600%
Sizes and Yield:

| Approximate | Cross Section | Approximate | Ends Per | Approximate |
|---|---|---|---|---|
| Cut Size | (inches) | Round Size | Ribbon | Yield (yds/lb) |
| 18 | .048 × .057 | 16 | 4-30 | 199 |
| 20 | .046 × .054 | 18 | 4-40 | 219 |
| 22 | .038 × .054 | 20 | 4-40 | 265 |
| 24 | .032 × .054 | 22 | 4-40 | 314 |
| 28 | .034 × .038 | 24 | 4-50 | 421 |
| 30 | .029 × .038 | 26 | 4-80 | 493 |
| 34 | .022 × .038 | 30 | 4-80 | 650 |
| 36 | .026 × .027 | 32 | 4-80 | 774 |
| 38 | .024 × .027 | 34 | 4-80 | 839 |
| 42 | .021 × .027 | 38 | 4-80 | 958 |
| 48 | .017 × .027 | 44 | 4-80 | 1184 |
| 50 | .015 × .027 | 46 | 4-80 | 1342 |
| 52 | .015 × .023 | 47 | 4-80 | 1575 |
| 53 | .013 × .027 | 48 | 4-80 | 1548 |
| 56 | .017 × .019 | 50 | 6-90 | 1682 |
| 58 | .015 × .019 | 52 | 6-90 | 1907 |
| 64 | .013 × .019 | 58 | 6-90 | 2200 |
| 66 | .012 × .019 | 60 | 6-90 | 2383 |

An elastic material made with the formulation of Example 1 was tested and Table 2 shows a comparison of the properties of the material with several standards or specifications:

TABLE 2

| Specification | | | | | Mil Spec |
|---|---|---|---|---|---|
| or Test | | NFPA | | | GL-PD-07- |
| article | Example 1 | 70E | CA OSHA | CGSB | 12 |
| After flame | 1.00 | <2.00 | <2.00 | <2.00 | <2.00 |
| (seconds) | | | | | |
| Afterglow | 0.00 | <25.00 | <25.00 | <25.00 | <25.00 |
| (inches) | | | | | |
| Char length | 0.10 | <6.00 | <6.00 | =<4.00 | <4.50 |
| (inches) | | | | | |
| Melting | None | None | None | None | None |
| Dripping | None | None | None | None | None |

It can be seen that the elastomeric material according to this invention meets or exceeds the tested requirements of all the specifications.

### Example 7

Table 3 shows a number of key properties of an elastic material made with the formulation of Example 1. The properties in Table 2 are measured using well known standards. Flame resistance is measured in accordance with ASTM D-6413; each result is reported as the average of ten tests.

TABLE 3

| Modulus at 300% | Permanent Set | | |
|---|---|---|---|
| strain | (20 minute test) | Hysteresis | Flame resistance |
| 500 +/− 20% | 18% maximum | <50% | After-flame (sec): 1.0 |
| | | | Char length (in): 0.1 |
| | | | Afterglow (sec): 0.0 |
| | | | No melting and |
| | | | dripping |

Hysteresis is measured as the extent of the transient deformation in the sample between the first and third maximum extensions (300%), expressed as percent loss from peak load in 1st cycle to peak load in third cycle. The permanent set is measured as the distention of the sample, in the direction of elongation, expressed as a percentage of the original length of the sample measured 20 minutes after the complete 3rd cycle.

The tensile strength was 2000 psi minimum, and the elongation was 400% minimum.

Each of the formulations of Example 2 also were tested for flame resistance and found to have after-flame of less than 2 seconds, char length of not more than 0.1 inches, and afterglow of 0 seconds.

### Other Embodiments

From the foregoing description, it will be apparent that variations and modifications may be made to the invention described herein to adopt it to various usages and conditions. Such embodiments are also within the scope of the following claims.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

All patents and publications mentioned in this specification are herein incorporated by reference to the same extent as if each independent patent and publication was specifically and individually indicated to be incorporated by reference.

1. A composition comprising:
(a) 100 parts polychloroprene-based polymer, comprising
(i) polychloroprene co-polymer; and
(ii) polychloroprene homopolymer;
wherein the ratio of (i) to (ii) is between 20:80 and 80:20;
(b) 30-90 parts flame retardant; and
(c) 3-9 parts curing agent.

2. The composition of claim 1, wherein the polychloroprene co-polymer is a polychloroprene co-polymer is a 2,3 dichloro 1,3-butadiene copolymer.

3. The composition of claim 1, wherein the polychloroprene co-polymer is Neoprene WRT and the polychloroprene homopolymer is Neoprene WB.

4. The composition of claim 1, wherein the ratio of (i) to (ii) is about 60:40.

5. The composition of claim 1, wherein the flame retardant comprises one or more of aluminum trihydroxide, chlorinated paraffin wax, antimony oxide, decabromo diphenyl ether, or zinc borate.

6. The composition of claim 1, wherein the curing agent comprises one or more of zinc oxide or salicylic acid.

7. The composition of claim 1, wherein the composition further comprises one or more of a peptizing agent, a pigment, a scorch inhibitor, a homogenizing agent, a cure activator, an antioxidant, or a release agent.

8. A composition comprising:
(a) 100 parts polychloroprene-based polymer, comprising
(i) about 60 parts polychloroprene co-polymer; and
(ii) about 40 parts polychloroprene homopolymer;
(b) 50-70 parts flame retardant, wherein the flame retardant comprises one or more of aluminum trihydroxide, chlorinated paraffin wax, antimony oxide, decabromo diphenyl ether, and zinc borate; and
(c) 5-7 parts curing agent, wherein the curing agent comprises zinc oxide and/or salicylic acid.

9. A composition comprising:
(a) 100 parts polychloroprene-based polymer, comprising
(i) about 60 parts polychloroprene co-polymer; and
(ii) about 40 parts polychloroprene homopolymer;
(b) 50-70 parts flame retardant, wherein the flame retardant comprises a mixture of aluminum trihydroxide, chlorinated paraffin wax, antimony oxide, and zinc borate; and
(c) 5-7 parts curing agent, wherein the curing agent comprises zinc oxide and salicylic acid.

10. A composition prepared by combining:
(a) 100 parts polychloroprene-based polymer, comprising
(i) polychloroprene co-polymer; and
(ii) polychloroprene homopolymer;
wherein the ratio of (i) to (ii) is between 20:80 and 80:20;
(b) 30-90 parts flame retardant; and
(c) 3-9 parts curing agent.

11. A composition which is prepared by combining:
(a) 100 parts polychloroprene-based polymer, comprising
(i) about 60 parts polychloroprene co-polymer; and
(ii) about 40 parts polychloroprene homopolymer;
(b) 50-70 parts flame retardant, wherein the flame retardant comprises one or more of aluminum trihydroxide, chlorinated paraffin wax, antimony oxide, decabromo diphenyl ether, and zinc borate; and
(c) 5-7 parts curing agent, wherein the curing agent comprises zinc oxide and/or salicylic acid.

12. An elastomeric thread comprising the composition of claim 1.

13. An elastomeric thread, wherein the elastomeric thread has modulus at 300% strain of at least 450 psi, and an after flame of no more than 1.1 seconds as measured by the method of ASTM D-6413.

14. A fabric comprising the elastomeric thread of claim 12.

15. An article of clothing comprising the fabric of claim 14.

16. An article of manufacture comprising the composition of claim 1.
